(19) United States
(12) Patent Application Publication
(10) Pub. No.: US 2023/0163482 A1
(43) Pub. Date: May 25, 2023

(54) INTEGRATED DIRECTIONAL ANTENNA FOR OUTDOOR WI-FI

(71) Applicant: Sterlite Technologies Limited, Gurugram (IN)

(72) Inventors: Vikas Jain, Gurugram (IN); Priyanka Khangarot, Gurugram (IN); Anand Kumar, Gurugram (IN)

(73) Assignee: Sterlite Technologies Limited, Gurugram (IN)

(21) Appl. No.: 17/697,336

(22) Filed: Mar. 17, 2022

(30) Foreign Application Priority Data
Nov. 24, 2021 (IN) 202111054308

(51) Int. Cl. H01Q 21/00; H01Q 21/30

(52) U.S. Cl. CPC H01Q 21/0075; H01Q 21/30; H01Q 21/0025

(57) ABSTRACT

The present disclosure provides a multiple-input multiple-output (MIMO) antenna element. The multiple-input multiple-output (MIMO) antenna element includes a radiating unit (202) having a first strip element (206), a second strip element (208) and a third strip element (210). In addition, the multiple-input multiple-output (MIMO) antenna element includes a grounding unit (204) having a grounding strip element positioned adjacent to the first strip element (206). The second strip element (208) connects the first strip element (206) with to the third strip element (210). The grounding strip element and the radiating unit (202) are separated by a gap.

### TECHNICAL FIELD

The present disclosure relates to the field of antennas and, in particular, relates to an integrated directional antenna for outdoor Wi-Fi.

### BACKGROUND

Over the last few years, there is an exponential increase in demand of wireless networks with the growth of mobile devices. Additionally, Wi-Fi networks have seen a huge increase in demand as well as broadened range of applications in the years since inception. Further, this broadened range of applications result in need to different antenna specifications to satisfy demand of the network and increased quality and efficiency of the network. Generally, antennas used in Wi-Fi radio are omni-directional antennas. An omni-directional antenna radiates electromagnetic waves uniformly in a specific plane (often in the azimuth plane) to provide a 360-degree horizontal radiation pattern covering all directions (horizontally) from the antenna with varying degrees of vertical coverage. Furthermore, power of the omni-directional antenna varies with the angle to the axis and declining to zero on the axis. This further leads to radiation of more energy in the horizontal direction and less energy at the higher and lower elevation angles by the omni-directional antenna. This results in poor coverage below the antenna. Moreover, the omni-directional dipole antennas fail to have proper patterning needed in order to connect to higher elevation and directly underneath.)

Also, the omni-directional antennas face higher interference which leads to difficulty in proper utilization of channels. In order to compensate for the interference, channel planning is required that turns out to be difficult considering the availability of channels in the unlicensed spectrum. The omni-directional antennas are best suited for indoor applications that require all around coverage. In light of the above stated discussion, there is a need for an efficient integrated directional antenna that overcomes the above stated disadvantages.

### OBJECT OF THE DISCLOSURE

A primary object of the present disclosure is to provide an integrated directional antenna with low interference.

Another object of the present disclosure is to provide the integrated directional antenna with better spatial reuse.

Yet another object of the present disclosure is to provide the integrated directional antenna with longer transmission range.

Yet another object of the present disclosure is to provide the integrated directional antenna with improved network capacity.

### SUMMARY

In an aspect, the present disclosure provides a multiple-input multiple-output (MIMO) antenna element. The multiple-input multiple-output (MIMO) antenna element includes a radiating unit having a first strip element, a second strip element and a third strip element. In addition, the multiple-input multiple-output (MIMO) antenna element includes a grounding unit having a grounding strip element positioned adjacent to the first strip element. The second strip element connects the first strip element with to the third strip element. The grounding strip element and the radiating unit are separated by a gap.

In an embodiment of the present disclosure, each strip element of each of the first MIMO antenna elements is defined by length edges and width edges. The second strip element connects at least one first width edge of the first strip element to at least one third width edge of the third strip element.

In an embodiment of the present disclosure, the first strip element and the grounding strip element are co-planar.

in an embodiment of the present disclosure, the first strip element and the third strip element are in parallel planes.

In an embodiment of the present disclosure, the second strip element is perpendicular to the first strip element.

In an embodiment of the present disclosure, dimension of the radiating unit is 123*42*0.8 (millimeter) in a first frequency band.

In an embodiment of the present disclosure, dimension of the radiating unit is 111*65.3*0.8 (millimeter) in a second frequency band.

In an embodiment of the present disclosure, the multiple-input multiple-output (MIMO) antenna element includes a co-axial cable in the gap between the grounding strip element and the radiating unit. The co-axial cable connects the third strip element and one end of the grounding strip element.

In another aspect, the present disclosure provides a multiple-input multiple-output (MIMO) antenna panel. The multiple-input multiple-output (MIMO) antenna panel includes a housing. The housing includes a first section housing, a first multiple-input multiple-output (MIMO) antenna module operating in a first frequency band. In addition, the housing includes a second section housing, a second MIMO antenna module operating in a second frequency hand. The first MIMO antenna module having a first pre-defined number of first MIME) antenna elements. The second MIMO antenna module having a second pre-defined number of second MIMO antenna elements.

In an embodiment of the present disclosure, the first MIMO antenna elements are arranged at corners of the first section. The first frequency band is 2.4 GHz and the first pre-defined number is 4*4.

In an embodiment of the present disclosure, the second MIMO antenna elements are arranged at corners and edges of the second section. The second frequency band is 5 GHz and the second pre-defined number is 8*8.

### STATEMENT OF THE DISCLOSURE

The present disclosure provides a multiple-input multiple-output (MIMO) antenna element. The multiple-input multiple-output (MIMO) antenna element includes a radiating unit having a first strip element, a second strip element and a third strip element. In addition, the multiple-input multiple-output (MIMO) antenna element includes a grounding unit having a grounding strip element positioned adjacent to the first strip element. The second strip element connects the first strip element with to the third strip element. The grounding strip element and the radiating unit are separated by a gap.

### BRIEF DESCRIPTION OF FIGURES

Having thus described the disclosure in general terms, reference will now be made to the accompanying figures, wherein:

FIG. 1 illustrates an isometric view of an integrated antenna assembly, in accordance with various embodiments of the present disclosure;

FIG. 2 illustrates an isometric view of a first MIMO antenna module, in accordance with various embodiments of the present disclosure;

FIG. 3 illustrates an isometric view of a second MIMO antenna module, in accordance with various embodiments of the present disclosure;

FIG. 4 illustrates an isometric view of a MIMO antenna panel, in accordance with various embodiments of the present disclosure;

FIG. 5 illustrates 3-dimensional radiation pattern for a first frequency band, in accordance with various embodiments of the present disclosure;

FIG. 6 illustrates 3-dimensional radiation pattern for a second frequency band, in accordance with various embodiments of the present disclosure;

FIG. 7 illustrates MIMO radiation pattern of azimuth plane for 2.4 GHz, 2.45 GHz and 2.5 GHz respectively, in accordance with various embodiments of the present disclosure;

FIG. 8 illustrates MIMO radiation pattern of elevation plane for 2.4 GHz, 2.45 GHz and 2.5 GHz respectively, in accordance with various embodiments of the present disclosure;

FIG. 9 illustrates MIMO radiation pattern of azimuth plane for 5.2 GHz, 5.5 GHz and 5.9 GHz respectively, in accordance with various embodiments of the present disclosure;

FIG. 10 illustrates MIMO radiation pattern of elevation plane for 5.2 GHz, 5.5 GHz and 5.9 GHz respectively, in accordance with various embodiments of the present disclosure;

FIG. 11 illustrates a plot of return loss for the first MIMO antenna module for the first frequency band, in accordance with various embodiments of the present disclosure;

FIG. 12 illustrates a plot of return loss for the second MIMO antenna module for the second frequency band, in accordance with various embodiments of the present disclosure;

FIG. 13 illustrates a plot of VSWR for the first MIMO antenna module for the first frequency band, in accordance with various embodiments of the present disclosure; and

FIG. 14 illustrates a plot of VSWR for the second MIMO antenna module for the second frequency band, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

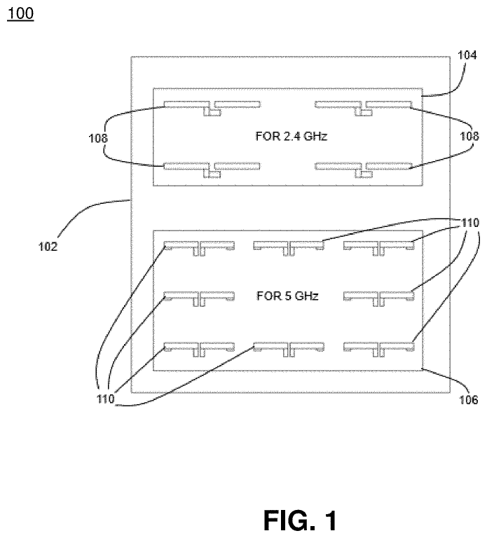

FIG. 1 illustrates an isometric view 100 of an integrated antenna assembly 102, in accordance with various embodiments of the present disclosure. The integrated antenna assembly 102 includes directional antennas that operate in 2.4 GHz and 5 GHz unlicensed frequency bands, where unlicensed frequency bands assigned for non-exclusive usage subject to some regulatory constraints. The integrated antenna assembly 102 is a patch antenna system. In general, patch antenna system is a type of antenna with a low profile that can be easily mounted on a surface. In addition, the integrated antenna assembly 102 is a linearly polarized (RFID tag orientation) antenna.

The integrated antenna assembly 102 includes a first multiple-input multiple-output (hereinafter, MIMO) antenna module 104 and a second MIMO antenna module 106. The first MIMO antenna module 104 includes a first pre-defined number of first MIMO antenna elements 108. In an embodiment of the present disclosure, the first pre-defined number of the first MIMO antenna elements 108 is 4*4. However, the first pre-defined number of the first MIMO antenna elements 108 may vary.

The first MIMO antenna module 104 operates in a first frequency band. In an embodiment of the present disclosure, the first frequency band is in a range of 2.3 GHz to 2.6 GHz. In another embodiment of the present disclosure, the first MIMO antenna module 104 operates in the first frequency hand of 2.4 GHz. Further, the second MIMO antenna module 106 includes a second pre-defined number of second MIMO antenna elements 110. In an embodiment of the present disclosure, the second pre-defined number of the second MIMO antenna elements 110 is 8*8. However, the second pre-defined number of the second MIMO antenna elements 110 may vary.

The second MIMO antenna module 106 operates in a second frequency band. In an embodiment of the present disclosure, the second frequency band is in range of 4.6 GHz to 6 GHz. In another embodiment of the present disclosure, the second MIMO antenna module 106 operates in the second frequency band of 5 GHz. The first MIMO antenna module 104 and the second MIMO antenna module 106 facilitates the integrated antenna assembly 102 to provide directive gain and high throughput.

The integrated antenna assembly 102 is useful for outdoor Wi-Fi applications. The integrated antenna assembly 102 sharply points directional radiation beam towards broadside direction along the vertical plane. In an example, the integrated antenna assembly 102 provides better coverage and performance in a stadium where one or more users are seated in a defined location. In an embodiment of the present disclosure, radiation pattern of the integrated antenna assembly 102 depends on alignment of the first MIMO antenna elements 108 and the second MIMO antenna elements 110. In general, radiation pattern refers to directional (angular) dependence of the strength of radio waves from the antenna or other source.

The integrated antenna assembly 102 focuses radio frequency energy into narrow beams in a particular direction. In addition, the integrated antenna assembly 102 focuses radio frequency energy in a particular direction to add gain. In general, there is an increase in coverage distance with increase in gain of a directional antenna. In addition, there is decrease in coverage angle or effective bandwidth with increase in gain of the directional antenna.

The integrated antenna assembly 102 allows concurrent transmissions in vicinity of transmitter and receiver. In addition, the integrated antenna assembly 102 faces less interference to provide structured coverage. Further, the integrated antenna assembly 102 is useful for point-to-point connections and for short to medium distance communication (indoors or outdoors). Furthermore, the integrated antenna assembly 102 has good spatial reuse, long transmission range and good network capacity.

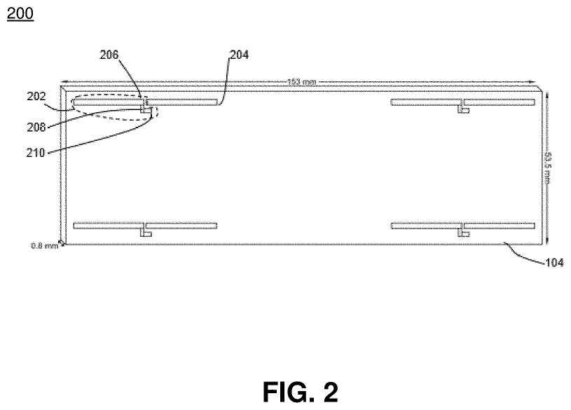

FIG. 2 illustrates an isometric view 200 of the first MIMO antenna module 104, in accordance with various embodiments of the present disclosure. The first MIMO antenna module 104 includes the first MIMO antenna elements 108. In addition, each of the first MIMO antenna elements 108 include a radiating unit 202 and a grounding unit 204.

Further, the radiating unit 202 includes a first strip element 206, a second strip element 208 and a third strip element 210. Furthermore, the grounding unit 204 includes a grounding strip element. The grounding strip element is positioned adjacent to the first strip element 206. Moreover, the first strip element 206, the second strip element 208, and the third strip element 210 are implemented on a single strip.

The second strip element 208 connects the first strip element 206 with the third strip element 210. In addition, the second strip element 208 is perpendicular to the first strip element 206. Further, the third strip element 210 is perpendicular to the second strip element 208. Furthermore, the third strip element 210 is parallel to the first strip element 206 and the grounding strip element.

The grounding strip element and the radiating unit 202 are separated by a gap. Each of the first MIMO antenna elements 108 is excited by a feed provided between the third strip element 210 and the grounding strip element. Each of the first MIMO antenna elements 108 include a co-axial cable in the gap. The co-axial cable is soldered in the gap between the grounding strip element and the radiating unit 202. The co-axial cable connects the third strip element 210 and one end of the grounding strip element. The co-axial cable connected between the third strip element 210 and the grounding strip element is used to provide the feed.

Each strip element of each of the first MIMO antenna elements 108 is defined by length edges and width edges. In addition, the second strip element 208 connects at least one first width edge of the first strip element 206 to at least one third width edge of the third strip element 210. (as shown in FIG. 2) The first strip element 206 and the grounding strip element are co-planar. Further, the first strip element 206 and the third strip element 210 are in parallel planes.

In an embodiment of the present disclosure, dimensions of the first strip element 206 are 21.5*1.5 (millimeter). In an embodiment of the present disclosure, dimensions of the second strip element 208 are 3*1 (millimeter). In an embodiment of the present disclosure, dimensions of the third strip element 210 are 2.5*1.75 (millimeter). In an embodiment of the present disclosure, dimensions of the grounding strip element are 21.5*1.5 (millimeter). In an embodiment of the present disclosure, dimensions of the radiating unit 202 are 123*42*0.8 (millimeter) for the first MIMO antenna module 104 in the first frequency band.

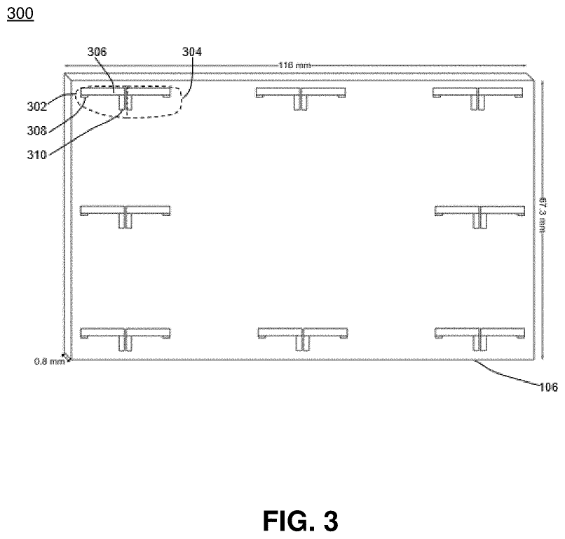

FIG. 3 illustrates an isometric view 300 of the second MIMO antenna module 106, in accordance with various embodiments of the present disclosure. The second MIMO antenna module 106 includes the second MIMO antenna elements 110. In addition, each of the second MIMO antenna elements 110 include a radiating unit 302 and a grounding unit 304. Further, the radiating unit 302 includes a first strip element 306, a second strip element 308 and a third strip element 310. Furthermore, the grounding unit 304 is positioned adjacent to the radiating unit 302.

The second strip element 308 is parallel to the first strip element 306. In addition, the third strip element 310 is perpendicular to the first strip element 306. Further, the radiating unit 302 is identical to the grounding unit 304 (as shown in FIG. 3). Furthermore, the grounding unit 304 and the radiating unit 302 are separated by a gap. Each of the second MIMO antenna elements 110 is excited by a feed provided between the radiating unit 302 and the grounding unit 304.

Each of the second MIMO antenna elements 110 include a co-axial cable in the gap. The co-axial cable is soldered in the gap between the grounding unit 304 and the radiating unit 302. The co-axial cable connected between the radiating unit 302 and the grounding unit 304 is used to provide the feed.

In an embodiment of the present disclosure, dimensions of the first strip element 306 are 8.85*2 (millimeter). In an embodiment of the present disclosure, dimensions of the second strip element 208 are 1.5*0.4 (millimeter). In an embodiment of the present disclosure, dimensions of the third strip element 210 are 3.1*1.2 (millimeter). In an embodiment of the present disclosure, dimensions of the radiating unit 302 are 111*65.3*0.8 (millimeter) for the second MIMO antenna module 106 in the second frequency band.

In an embodiment of the present disclosure, value of 3 dB beamwidth for 2.4 GHz is 34° for H-plane and 42° for V-plane. In an embodiment of the present disclosure, value of 3 dB beamwidth for 5 GHz is 20° for H-plane and 23° for V-plane. In an embodiment of the present disclosure, value of return loss for 2.4 GHz is less than −17.5 dB. In an embodiment of the present disclosure, value of return loss for 5 GHz is less than −20 dB. In general, return loss focuses at amount of power absorbed by a load when power from a source is sent to it. In addition, return loss is the difference between incident power and reflected power. In an embodiment of the present disclosure, value of 10 dB bandwidth for 2.4 GHz is 300 MHz. In an embodiment of the present disclosure, value of 10 dB bandwidth for 5 GHz is 1400 MHz.

In an embodiment of the present disclosure, value of 3 dB beamwidth for 2.43 GHz is 34° for H-plane and 44° for V-plane. In an embodiment of the present disclosure, value of 3 dB beamwidth for 2.45 GHz is 34° for H-plane and 46° for V-plane. In an embodiment of the present disclosure, value of 3 dB beamwidth for 2.49 GHz is 34° for H-plane and 46° for V-plane. In an embodiment of the present disclosure, value of 3 dB beamwidth for 2.5 GHz is 35° for H-plane and 45° for V-plane.

In an embodiment of the present disclosure, value of Front to Back ratio for 2.4 GHz is 23 dB for H-plane and 20 dB for V-plane. In an embodiment of the present disclosure, value of Front to Back ratio for 2.43 GHz is 24 dB for H-plane and 30 dB for V-plane. In an embodiment of the present disclosure, value of Front to Back ratio for 2.45 GHz is 29 dB for H-plane and 38 dB for V-plane. In an embodiment of the present disclosure, value of Front to Back ratio for 2.49 GHz is 34 dB for H-plane and 30 dB for V-plane. In an embodiment of the present disclosure, value of Front to Back ratio for 2.5 GHz is 32 dB for H-plane and 34 dB for V-plane.

In an embodiment of the present disclosure, value of 3 dB beamwidth for 5 GHz is 22° for H-plane and 31° for V-plane. In an embodiment of the present disclosure, value of 3 dB beamwidth for 5.2 GHz is 22° for H-plane and 30° for V-plane. In an embodiment of the present disclosure, value of 3 dB beamwidth for 5.5 GHz is 20° for H-plane and 26° for V-plane. In an embodiment of the present disclosure, value of 3 dB beamwidth for 5.7 GHz is 21° for H-plane and 23° for V-plane. In an embodiment of the present disclosure, value of 3 dB beamwidth for 5.9 GHz is 22° for H-plane and 27° for V-plane.

In an embodiment of the present disclosure, value of Front to Back ratio for 5 GHz is 31 dB for H-plane and 28 dB for V-plane. In an embodiment of the present disclosure, value of Front to Back ratio for 5.2 GHz is 35 dB for H-plane and 28 dB for V-plane. In an embodiment of the present disclosure, value of Front to Back ratio for 5.5 GHz is 28 dB for H-plane and 30 dB for V-plane. In an embodiment of the present disclosure, value of Front to Back ratio for 5.7 GHz is 31 dB for H-plane and 25 dB for V-plane. In an embodiment of the present disclosure, value of Front to Back ratio for 5.9 GHz is 28 dB for H-plane and 31 dB for V-plane.

In an embodiment of the present disclosure, value of peak gain of the first antenna module for 2.4 GHz is 12.9 dBi. In general, peak gain is a measure of input power concentration in main beam direction as a ratio relative to an isotropic antenna source. In addition, peak gain is determined as ratio of maximum power density in main beam peak direction, at a defined input power, compared to power density of a loss less isotropic radiator with same input power. Further, peak gain is defined in the far-field of antenna.

In an embodiment of the present disclosure, value of peak gain of the first antenna module for 2.43 GHz is 13.4 dBi. In an embodiment of the present disclosure, value of peak gain of the first antenna module for 2.45 GHz is 13.7 dBi. In an embodiment of the present disclosure, value of peak gain of the first antenna module for 2.49 GHz is 12.9 dBi. In an embodiment of the present disclosure, value of peak gain of the first antenna module for 2.5 GHz is 12.5 dBi.

In an embodiment of the present disclosure, value of peak gain of the first antenna module for 5 GHz is 16 dBi. In an embodiment of the present disclosure, value of peak gain of the first antenna module for 5.2 GHz is 17.1 dBi. In an embodiment of the present disclosure, value of peak gain of the first antenna module for 5.5 GHz is 15.6 dBi. In an embodiment of the present disclosure, value of peak gain of the first antenna module for 5.7 GHz is 16.4 dBi. In an embodiment of the present disclosure, value of peak gain of the first antenna module for 5.9 GHz is 17.1 dBi.

In an embodiment of the present disclosure, value of Voltage Standing Wave Ratio (hereinafter, VSWR) is less than 1.5 for both 2.4 GHz and 5 GHz. In general, VSWR is a measure of how efficiently radio-frequency power is transmitted from a power source (power amplifier, for example), through a transmission line, into a load (antenna, for example). In an embodiment of the present disclosure, value of antenna gain for 2.4 GHz is 13.7 dBi. In an embodiment of the present disclosure, value of antenna gain for 5 GHz is 17.1 dBi. In an embodiment of the present disclosure, value of Front to Back ratio for 2.4 GHz is 38 dB. In an embodiment of the present disclosure, value of Front to Back ratio for 5 GHz is 35 dB.

In an embodiment of the present disclosure, peak gain of single antenna is in range of 10 dBi to 12 dBi for both 2.4 GHz and 5 GHz. In an embodiment of the present disclosure, cross polarization is used for both 2.4 GHz and 5 GHz.

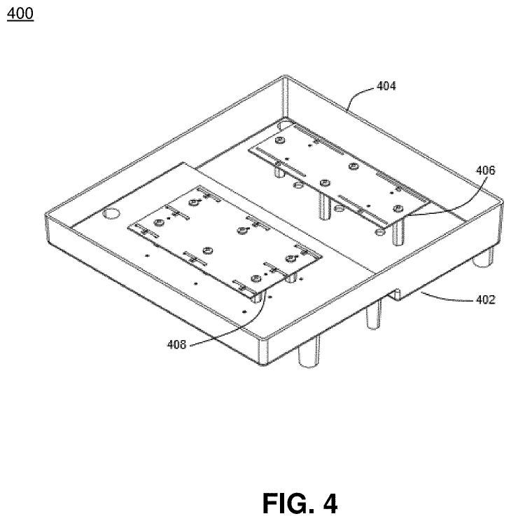

FIG. 4 illustrates an isometric view 400 of a MIMO antenna panel 402, in accordance with various embodiments of the present disclosure. The MIMO antenna panel 402 includes a housing 404. The housing 404 includes a first section 406 and a second section 408. The first section 406 houses the first MIMO antenna module 104. The first MIMO antenna module 104 operates in the first frequency band of 2.4 GHz.

The second section 408 houses the second MIMO antenna module 106. The second MIMO antenna module 106 operates in the second frequency band of 5 GHz. The MIMO antenna panel 402 includes a plurality of printed circuit boards. In an embodiment of the present disclosure, number of the plurality of printed circuit boards is two. The plurality of printed circuit boards includes a first printed circuit board and a second printed circuit board. The first MIMO antenna module 104 is implemented on the first printed circuit board. The second MIMO antenna module 106 is implemented on the second printed circuit board.

The first printed circuit board includes four of the first MIMO antenna modules 104. In addition, the first printed circuit board includes four of the first MIMO antenna modules 104 operating in range of 2.3 GHz to 2.6 GHz. The second printed circuit board includes eight of the second MIMO antenna modules 106. Further, the second printed circuit board includes eight of the second MIMO antenna modules 106 operating in range of 4.6 GHz to 6 GHz.

In an embodiment of the present disclosure, dimensions of the housing 404 are 220*200*30 (millimeter). In an embodiment of the present disclosure, dimensions of the integrated antenna assembly 102 depend on required performance of the integrated antenna assembly 102. In addition, change in dimension of the integrated antenna assembly 102 affects frequency of the integrated antenna assembly 102.

In an embodiment of the present disclosure, the radiating unit 202 and the grounding unit 204 are implemented on single side of the first printed circuit board. In an embodiment of the present disclosure, the radiating unit 302 and the grounding unit 304 are implemented on single side of the second printed circuit board. In an embodiment of the present disclosure, metal is used on the single side of the first printed circuit board. In an embodiment of the present disclosure, metal is used on the single side of the second printed circuit board.

In an embodiment of the present disclosure, value of return loss at center frequency is −17.5 dB for the first frequency band. In an embodiment of the present disclosure, value of return loss at center frequency is −20 dB for the first frequency band. In an embodiment of the present disclosure, value of VSWR is less than 1.5 for the first frequency band. In an embodiment of the present disclosure, value of VSWR is less than 1.8 for the second frequency band.

In an embodiment of the present disclosure, value of Front to Back ratio is 36 dB for the first frequency band. In an embodiment of the present disclosure, value of Front to Back ratio is 34 dB for the second frequency band. In an embodiment of the present disclosure, value of vertical beamwidth is 37° and value of horizontal beamwidth is 38° for the first frequency band. In an embodiment of the present disclosure, value of vertical beamwidth is 18° and value of horizontal beamwidth is 21° for the second frequency band. In an embodiment of the present disclosure, value of isolation is less than −18 dB for the first frequency band. In an embodiment of the present disclosure, value of isolation is less than −20 dB for the second frequency band.

The first MIME) antenna elements 108 are arranged at corners of the first section 406 to maximize spacing between each of the first MIMO antenna elements 108. In addition, the second MIMO antenna elements 110 are arranged at corners and edges of the second section 408 to maximize spacing between each of the second. MIMO antenna elements 110. Further, the spacing is determined to achieve desired isolation factor. Furthermore, the spacing is determined based on mutual coupling performance In general, mutual coupling is an electromagnetic interaction phenomenon that exists between antenna elements in an array. In addition, mutual coupling effect on channel estimation and capacity of MIMO antenna systems. In general, mutual coupling becomes better with increase in separation between antenna strips.

Further, mutual coupling is quantified by measuring isolation factor of antenna. In general, antenna isolation is a measure of ease with which one antenna picks up radiation from another antenna. In general, isolation is set at least greater than +20 dB, but depends on product. Furthermore, isolation is measured with a vector network analyzer.

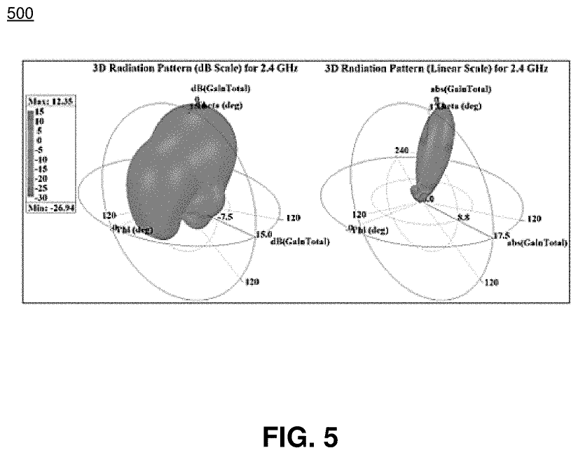

FIG. 5 illustrates 3-dimensional radiation pattern 500 for a first frequency band, in accordance with various embodiments of the present disclosure.

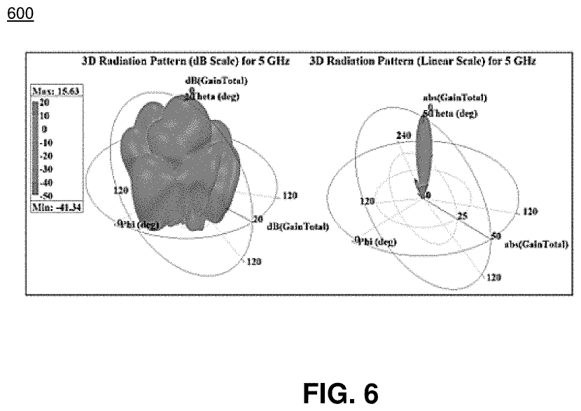

FIG. 6 illustrates 3-dimensional radiation pattern 600 for a second frequency band, in accordance with various embodiments of the present disclosure.

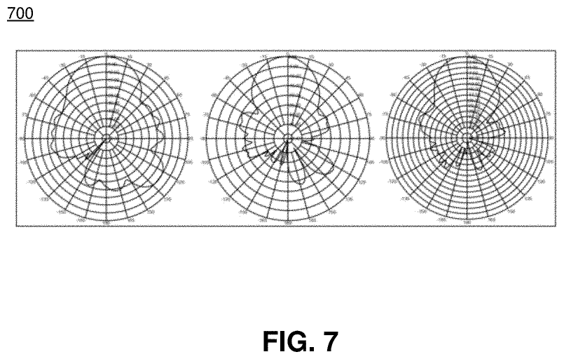

FIG. 7 illustrates MIMO radiation pattern 700 of azimuth plane for 2.4 GHz, 2.45 GHz and 2.5 GHz respectively, in accordance with various embodiments of the present disclosure.

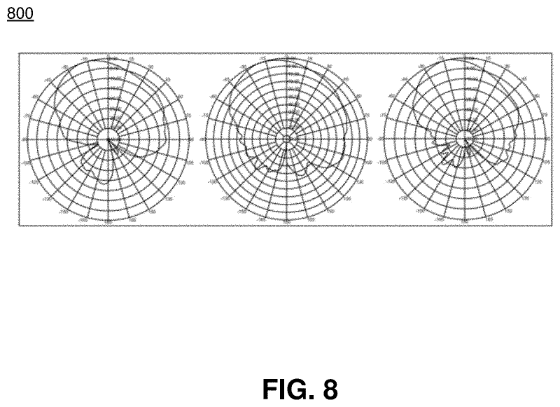

FIG. 8 illustrates MIMO radiation pattern 800 of elevation plane for 2.4 GHz, 2.45 GHz and 2.5 GHz respectively, in accordance with various embodiments of the present disclosure.

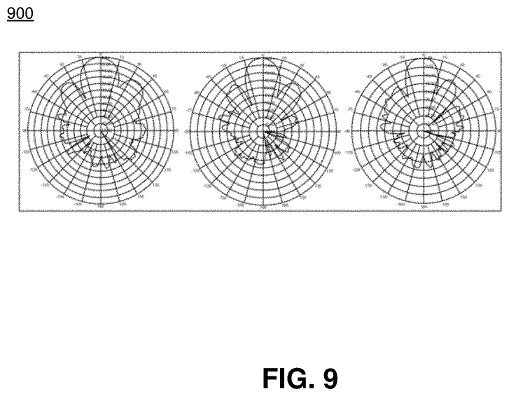

FIG. 9 illustrates MIMO radiation pattern 900 of azimuth plane for 5.2 GHz, 5.5 GHz and 5.9 GHz respectively, in accordance with various embodiments of the present disclosure.

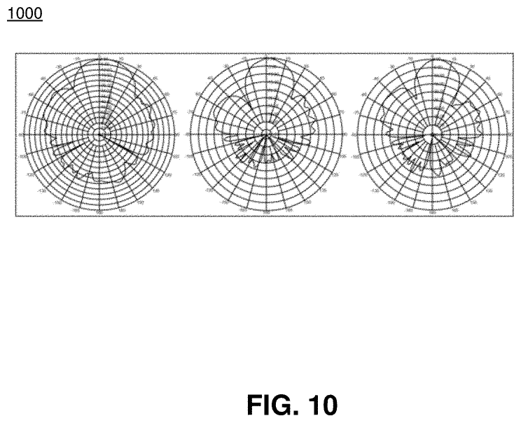

FIG. 10 illustrates MIMO radiation pattern 1000 of elevation plane for 5.2 GHz, 5.5 GHz and 5.9 GHz respectively, in accordance with various embodiments of the present disclosure.

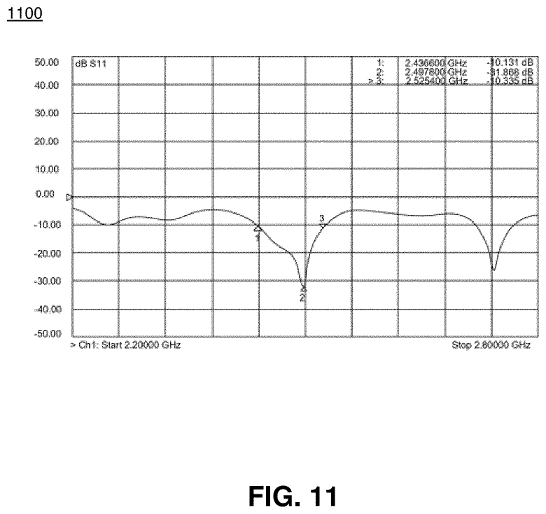

FIG. 11 illustrates a plot 1100 of return loss for the first MIMO antenna module 104 for the first frequency band, in accordance with various embodiments of the present disclosure.

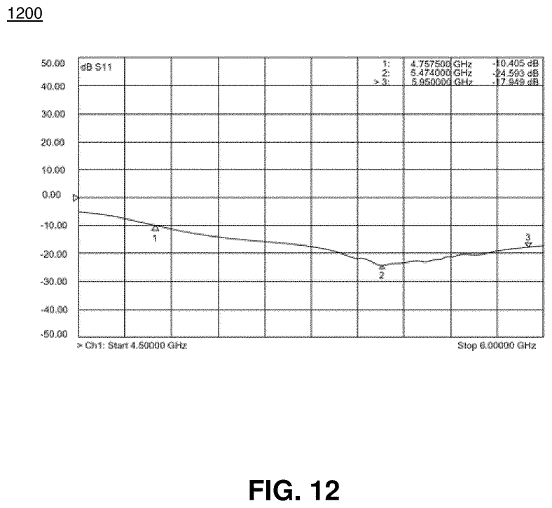

FIG. 12 illustrates a plot 1200 of return loss for the second MIMO antenna module 106 for the second frequency band, in accordance with various embodiments of the present disclosure.

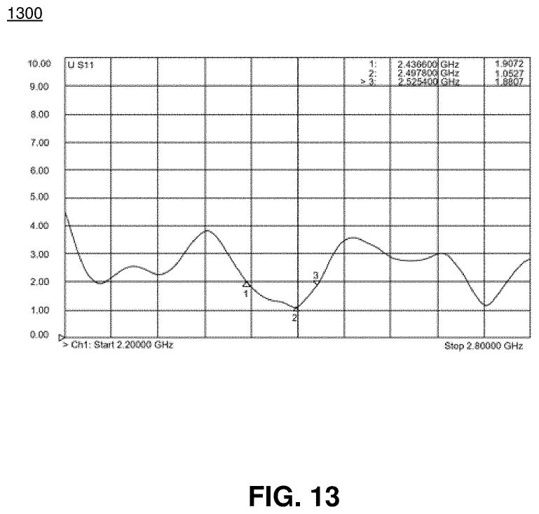

FIG. 13 illustrates a plot 1300 of VSWR for the first MIMO antenna module 104 for the first frequency band, in accordance with various embodiments of the present disclosure.

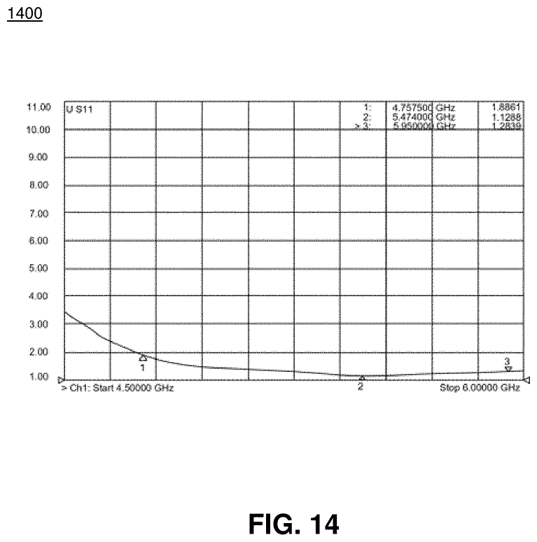

FIG. 14 illustrates a plot 1400 of VSWR for the second MIMO antenna module 106 for the second frequency band, in accordance with various embodiments of the present disclosure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A multiple-input multiple-output (MIMO) antenna element comprising:
a radiating unit (202) having a first strip element (206), a second strip element (208) and a third strip element (210), wherein the second strip element (208) connects the first strip element (206) with the third strip element (210); and
a grounding unit (204) having a grounding strip element positioned adjacent to the first strip element (206), wherein the grounding strip element and the radiating unit (202) are separated by a gap.

2. The multiple-input multiple-output (MIMO) antenna element as claimed in claim 1, wherein each strip element of each of the multiple-input multiple-output antenna elements is defined by length edges and width edges, wherein the second strip element (208) connects at least one first width edge of the first strip element (206) to at least one third width edge of the third strip element (210).

3. The multiple-input multiple-output (MIMO) antenna element as claimed in claim 1, wherein the first strip element (206) and the grounding strip element are co-planar.

4. The multiple-input multiple-output (MIMO) antenna element as claimed in claim 1, wherein the first strip element (206) and the third strip element (210) are in parallel planes.

5. The multiple-input multiple-output (MIMO) antenna element as claimed in claim 1, wherein the second strip element (208) is perpendicular to the first strip element (206).

6. The multiple-input multiple-output (MIMO) antenna element as claimed in claim 1, wherein the radiating unit (202) has dimensions of 123*42*0.8 (millimeter) in a first frequency band.

7. The multiple-input multiple-output (MIMO) antenna element as claimed in claim 1, wherein a radiating unit (302) has dimensions of 111*65.3*0.8 (millimeter) in a second frequency band.

8. The multiple-input multiple-output (MIMO) antenna element as claimed in claim 1, further comprising, a co-axial cable in the gap between the grounding strip element and the radiating unit (202), wherein the co-axial cable connects the third strip element (210) and one end of the grounding strip element.

9. A multiple-input multiple-output (MIMO) antenna panel (402) comprising:
a housing (404) comprising:
a first section (406) housing a first multiple-input multiple-output (MIMO) antenna module (104) operating in a first frequency hand, wherein the first MIMO antenna module (104) having a first pre-defined number of first MIMO antenna elements (108); and
a second section (408) housing a second MIME) antenna module (106) operating in a second frequency band, wherein the second MIMO antenna module (106) having a second pre-defined number of second MIMO antenna elements (110).

10. The multiple-input multiple-output (MIMO) antenna panel (402) as claimed in claim 9, wherein the first MIMO antenna elements (108) are arranged at corners of the first section (406), wherein the first frequency band is 2.4 GHz and the first pre-defined number is 4*4.

11. The multiple-input multiple-output (MIME)) antenna panel (402) as claimed in claim 9, wherein the second MIMO antenna elements (110) are arranged at corners and edges of the second section (408), wherein the second frequency band is 5 GHz and the second pre-defined number is 8*8.
